(19) United States
(12) Patent Application Publication
(10) Pub. No.: US 2021/0224719 A1
(43) Pub. Date: Jul. 22, 2021

(54) PROBLEM RECORD MANAGEMENT USING EXPERTISE SCORE VECTOR

(71) Applicant: International Business Machines Corporation, Armonk, NY (US)

(72) Inventors: Andrew C. M. Hicks, Wappingers Falls, NY (US); Michael Terrence Cohoon, Fishkill, NY (US); RYAN THOMAS RAWLINS, New Paltz, NY (US); MICHAEL E. GILDEIN, Wappingers Falls, NY (US)

(21) Appl. No.: 16/749,019

(22) Filed: Jan. 22, 2020

(51) Int. Cl. G06Q 10/06; G06Q 10/10

(52) U.S. Cl. CPC G06Q 10/063114; G06Q 10/101; G06Q 10/06398

(57) ABSTRACT

Techniques for problem record management using an expertise score vector for software component management are described herein. An aspect includes receiving a problem record associated with a first work item of a software component, the first work item being associated with a first developer. Another aspect includes creating a second work item corresponding to the problem record. Another aspect includes assigning the second work item to a second developer. Another aspect includes determining that computer code from the second developer resolves the problem record. Another aspect includes, based on determining that the problem record is resolved, increasing an expertise score of the second developer.

### BACKGROUND

The present invention generally relates to computer systems, and more specifically, to problem record management using an expertise score vector for software component management in a computer system.

Computer systems control almost every aspect of our life—from writing documents to controlling traffic lights. Such computer systems are controlled by software components that may be written by teams of software developers. The software components may be relatively complex, requiring relatively large numbers of developers working together to produce and maintain computer code that is executed on a computer system. Further, computer systems may be often error-prone, and thus require a testing phase in which any errors should be discovered. The testing phase is considered one of the most difficult tasks in designing a computer system. The cost of not discovering an error may be enormous, as the consequences of the error may be disastrous.

### SUMMARY

Embodiments of the present invention are directed to problem record management using an expertise score vector for software component management. A non-limiting example computer-implemented method includes receiving a problem record associated with a first work item of a software component, the first work item being associated with a first developer. The method also includes creating a second work item corresponding to the problem record. The method also includes assigning the second work item to a second developer. The method also includes determining that computer code from the second developer resolves the problem record. The method also includes, based on determining that the problem record is resolved, increasing an expertise score of the second developer.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of an example computer system for use in conjunction with one or more embodiments of problem record management using an expertise score vector;

FIG. 2 is a flow diagram of a process for problem record management using an expertise score vector in accordance with one or more embodiments of the present invention;

FIG. 3 is a flow diagram of a process for problem record management using an expertise score vector in accordance with one or more embodiments of the present invention;

FIG. 4 is a flow diagram of a process for problem record management using an expertise score vector in accordance with one or more embodiments of the present invention; and

FIGS. 5A and 5B are block diagrams of components of a system for problem record management using an expertise score vector in accordance with one or more embodiments of the present invention.

### DETAILED DESCRIPTION

One or more embodiments of the present invention provide problem record management using an expertise score vector for software component management. An organization may produce and maintain computer software products for use on computer systems that include multiple software components. Each software component may be assigned a team of developers that are responsible for the software component. Creating software (i.e., developing) for different computer systems that implement relatively complex software components may require specialized knowledge and skills by a software developer. Such knowledge and skills may be gained through experience developing for a particular computer system and/or software component. In order to maintain relatively high quality in software that is produced by an organization, respective expertise score vectors may be maintained for each developer in an organization to identify levels of skills and component mastery for individual developers. Work items may be assigned to developers based on expertise scores that are determined based on the expertise score vectors. For example, a more experienced developer having a higher expertise score may be assigned relatively complex work items, while a less experienced developer having a lower expertise score may be assigned relatively simple work items.

Over the lifecycle of a software component, many work items corresponding to tasks may be created, assigned, tracked, and completed. As work items are completed, information regarding the work items may be extracted to understand the purpose of each work item, for example, whether a work item added a new feature to the software component or fixed a problem in an existing feature of the software component. For a work item that fixes a problem with an existing feature, the work item may be linked back to an original work item that created the feature and therefore may have introduced the problem. Tracking of ownership of work items that introduced problems into the software component and ownership of work items that resolved problems in the software component may be performed for each developer on a team.

When a problem is introduced into, or resolved in, a software component, one or more metrics may be updated in an expertise score vector of a developer that owns a work item corresponding to the problem. For example, if a developer is determined to have introduced a problem into the software component, an expertise score of the developer may be reduced. If a developer is determined to have resolved a problem in the software component, the developer's expertise score may be increased. A set of work items that successfully resolved a problem in the software component may be identified, and corresponding expertise scores of the developers that own the identified set of work items may be averaged to determine a mean expertise score required to resolve problems in the software component.

In some embodiments, a software development project may use a software development platform, such as GitHub and ZenHub, for project management, code version control, and issue tracking for a software component. If a code commit introduces a bug into the software component, an issue may be opened and tethered to the commit that introduced the bug. An expertise score of the developer(s) that own the tethered commit may be lowered. Based on the bug being resolved, the expertise score of the developer(s) that resolved the bug may be increased.

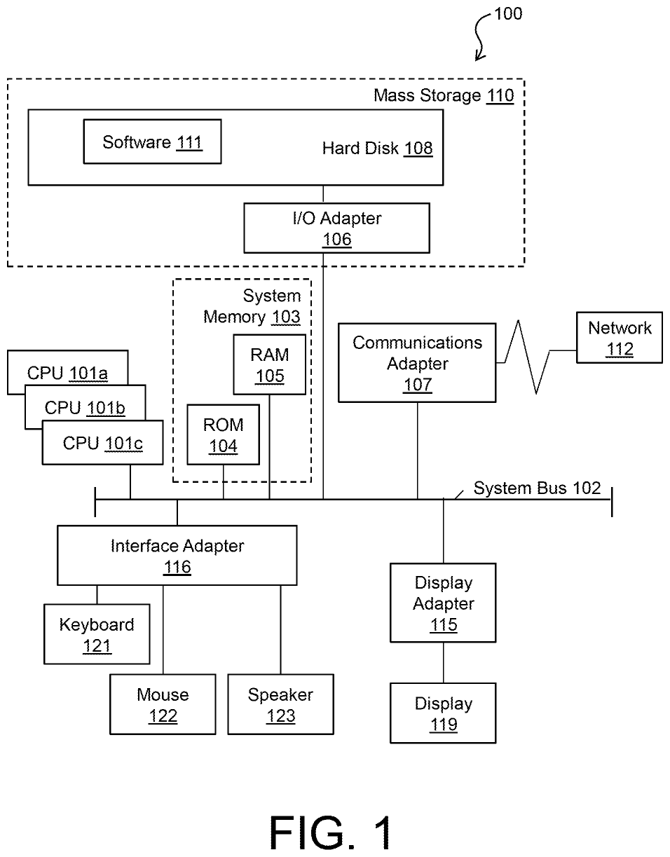

Turning now to FIG. 1, a computer system 100 is generally shown in accordance with an embodiment. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc. (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system, such as the z/OS or AIX operating system from IBM Corporation, to coordinate the functions of the various components shown in FIG. 1.

Additional input/output devices are shown as connected to the system bus 102 via a display adapter 115 and an interface adapter 116 and. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by a display adapter 115, which may include a graphics controller to improve the performance of graphics intensive applications and a video controller. A keyboard 121, a mouse 122, a speaker 123, etc. can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

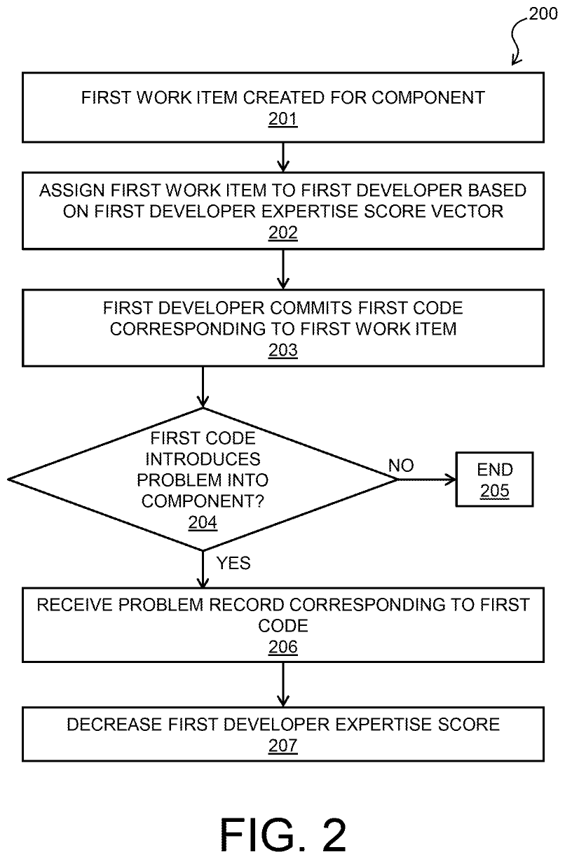

Turning now to FIG. 2, a process flow diagram of a method 200 for problem record management using an expertise score vector is generally shown in accordance with one or more embodiments of the present invention. Method 200 may be implemented in conjunction with any appropriate computer system, such as computer system 100 of FIG. 1. In block 201 of method 200, a first work item is created for a software component. The first work item may be created based on, for example, a new feature request for the software component. In block 202, the first work item is assigned to a first developer based on a first expertise score vector that is associated with the first developer. The assigning may be performed based on any appropriate information from an expertise score vector associated with the first developer, and may include determining an expertise score based on a subset of fields in the expertise score vector and comparing the expertise score that was determined for the first developer to expertise scores associated with other developers on a team corresponding to the software component.

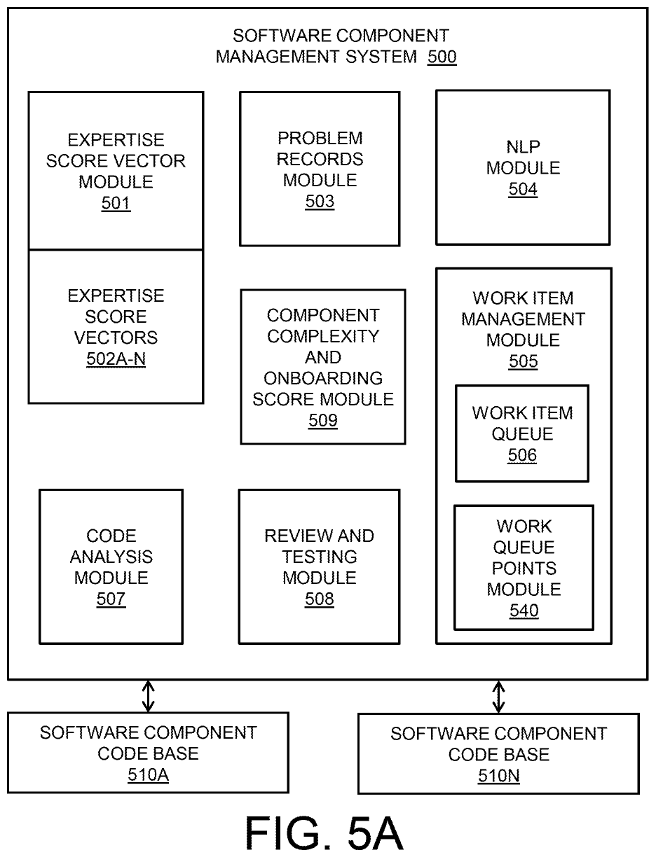

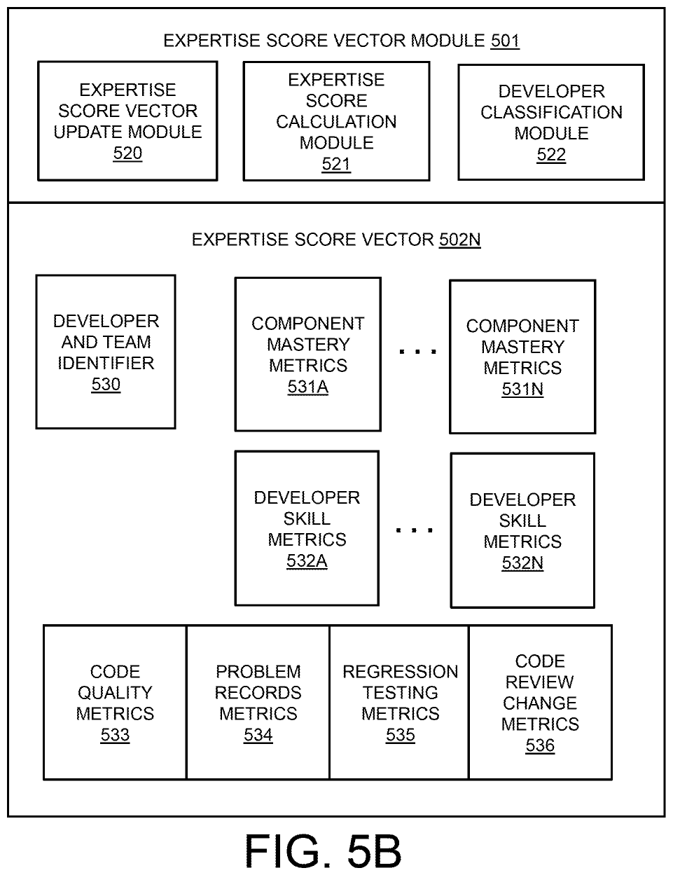

In block 203, the first developer commits first code corresponding to the first work item to a code base corresponding to the software component. Review and testing of the first code may be performed based on the committing of the first code in block 203, and the first code may be deployed in block 203 based on successful completion of the review and testing. In block 204, it is determined whether the first code introduced a problem into the software component. The problem may be determined to exist any time after deployment of the first code in some embodiments. If it is determined in block 204 that the first code did not introduce a problem into the software component, flow proceeds from block 204 to block 205, and method 200 ends. If it is determined in block 204 that the first code did introduce a problem into the component, flow proceeds from block 204 to block 206. In block 206, a problem record corresponding to the first code is received. Flow then proceeds to block 207, in which the expertise score vector associated with the developer is updated based on the problem record that was received in block 206. For example, a problem records metric in the expertise score vector corresponding to the first developer may be decreased in block 207, such that an expertise score that is calculated for the first developer using the problem records metric is also decreased. Embodiments of method 200 may be implemented in software component management system 500 of FIG. 5A, which is discussed in further detail below.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

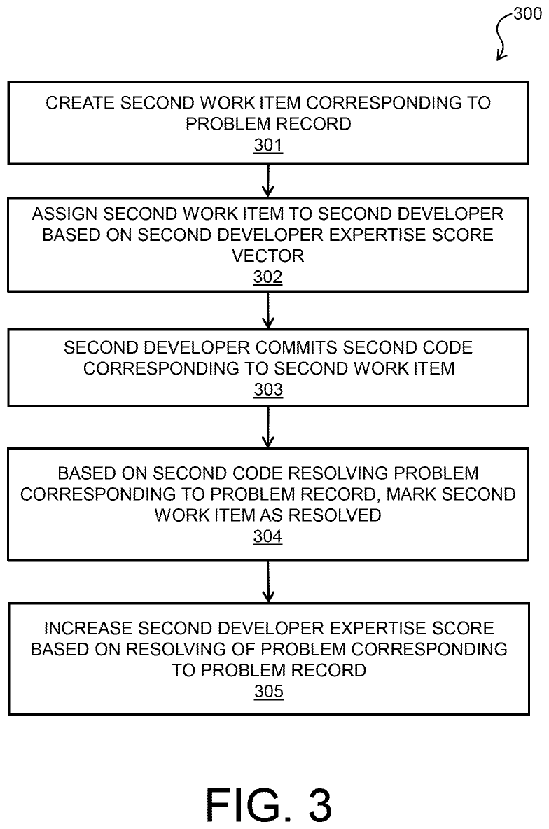

FIG. 3 shows a process flow diagram of a method 300 for problem record management using an expertise score vector in accordance with one or more embodiments of the present invention. Method 300 may be implemented in conjunction with any appropriate computer system, such as computer system 100 of FIG. 1. In block 301, a second work item corresponding to a problem record that was received for a software component, such as the problem record that was received in block 206 of method 200 of FIG. 2, is created. In some embodiments, the second work item may be created based on applying natural language processing (NLP) to the problem record to extract keywords from the problem record. In some embodiments, the second work item may be tethered to the problem record, such that the second work item is tracked by a work item management module based on the association between the second work item and the problem record. In block 302, the second work item is assigned to a second developer based on the second developer's expertise score vector. The assigning may be performed based on any appropriate information from an expertise score vector associated with the second developer, and may include determining an expertise score based on a subset of fields in the expertise score vector and comparing the expertise score that was determined for the second developer to expertise scores associated with other developers on a team corresponding to the software component. In some embodiments, the assigning of block 302 may be performed based on an amount of time the code corresponding to the problem record has been deployed in the field. For example, for code that has been deployed a relatively long time before the problem record was generated, the second work item may be assigned to a developer having a higher expertise score.

In block 303, the second developer commits second code corresponding to the second work item. Review and testing of the second code may be performed based on the committing of the second code in block 303, and the second code may be deployed in block 303 based on successful completion of the review and testing. In block 304, based on the second code resolving the problem associated with the problem record, the second work item is marked as resolved. The second work item may be marked as resolved in a work item management module in some embodiments. In some embodiments, marking may be performed based on the second work item being tethered to the problem record by a work item management module, as discussed above with respect to block 301. In block 305, the expertise score vector associated with the second developer is updated based on the second code resolving the problem corresponding to the second work item. For example, a problem records metric in the expertise score vector corresponding to the second developer may be increased in block 305, such that an expertise score that is calculated for the first developer using the problem records metric would also increase. Embodiments of method 300 may be implemented in software component management system 500 of FIG. 5A, which is discussed in further detail below.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

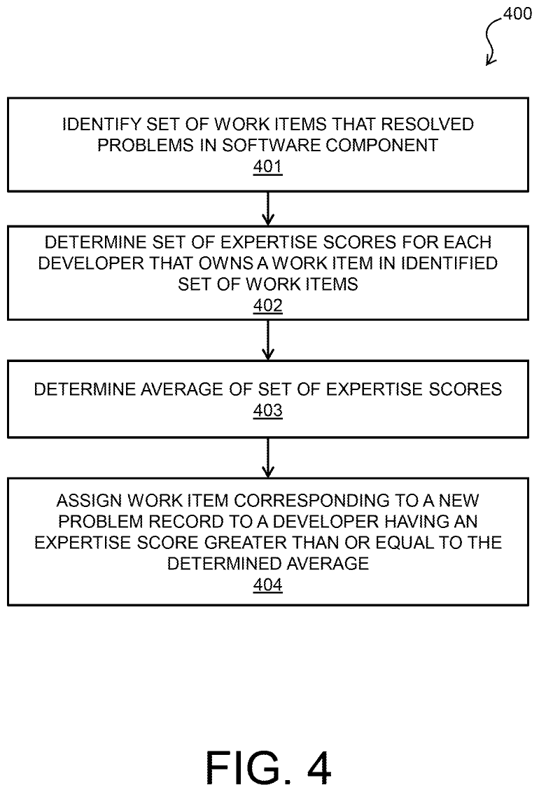

FIG. 4 shows a process flow diagram of a method 400 for problem record management using an expertise score vector in accordance with one or more embodiments of the present invention. Method 400 may be implemented in conjunction with any appropriate computer system, such as computer system 100 of FIG. 1. In block 401, a set of work items that resolved corresponding problems in a particular software component are identified. The set of work items may be identified based on determining any work items associated with the software component that are marked as resolved by a work item management module, as discussed above with respect to block 304 of method 300 of FIG. 3. The respective developer(s) that is associated with each work item of the set of work items is also determined in block 401 of FIG. 4.

In block 402, a set of expertise scores corresponding to the determined developers that were assigned to the identified set of work items are identified. The expertise scores may be determined in block 402 based on respective expertise score vectors that are associated with each of the determined developers. In various embodiments, any appropriate fields in an expertise score vector may be used to determine an expertise score in block 402. For example, fields in the expertise score vector that are related to the particular software component may be used to determine the expertise scores in block 402. In block 403, an average of the set of expertise scores that were determined in block 402 is determined. In block 404, a new problem record is received for the software component, and a new work item corresponding to the new problem record is assigned to a developer having an expertise score that is greater than or equal to the average expertise score that was determined in block 403. Embodiments of method 400 may be implemented in software component management system 500 of FIG. 5A, which is discussed in further detail below.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

Turning now to FIG. 5A, a software component management system 500 that includes an expertise score vector is generally shown in accordance with one or more embodiments of the present invention. Software component management system 500 may be implemented in conjunction with any appropriate computer system(s), including but not limited to computer system 100 of FIG. 1. Software component management system 500 is in communication with software component code bases 510A-N, which each include computer code written by one or more developers on teams corresponding to various software components. The software component management system 500 includes an expertise score vector module 501, which may maintain a respective expertise score vector of expertise score vectors 502A-N for each developer across various teams in the organization. Expertise score vector module 501 and expertise score vectors 502A-N are discussed in further detail below with respect to FIG. 5B.

Software component management system 500 includes a problem records module 503, which receives and manages problem records (e.g., bug reports) regarding the software component code bases 510A-N. NLP module 504 performs analysis of problem records that are received by problem records module 503 and may, for example, output keywords that are identified in a problem record to work item management module 505. Work item management module 505 creates work items based on problem records that are received by problem records module 503. The work items may be created by work item management module 505 based on keywords that were identified by NLP module 504 in some embodiments. Work item management module 505 may also create work items based on new feature requests for the software components corresponding to software component code bases 510A-N. Created work items are placed in a work item queue 506 by work item management module 505. The work items in work item queue 506 are assigned to developers by work item management module 505 based on input from expertise score vector module 501 and data from the developers' respective expertise score vectors 502A-N. Work item management module 505 may track work items that are in development in work item queue 506, and mark work items as resolved as described above with respect to method 300 of FIG. 3. Work queue points module 540 may track a respective workload for each developer that is currently assigned to any work items in work item queue 506.

When new code is committed by a developer into any of software component code bases 510A-N, code analysis module 507 may review the new to determine a code quality of the new code. Review and testing module 508 may determine and apply a review and testing process to new code, and may also assign one or more developers to the review and testing process based on expertise score vectors 502A-N. Review and testing module 508 may also provide data regarding the review and testing of code to expertise score vector module 501.

Component complexity and onboarding score module 509 may determine a relative component complexity and an onboarding score for each software component corresponding to software component code bases 510A-N. Component complexity and onboarding score module 509 may operate based on component mastery metrics 531A-N and developer classification module 522 of FIG. 5B, which are discussed below.

Embodiments of method 200 of FIG. 2 may be implemented in software component management system 500. For example, work item management module 505 may create and assign the first work item to a first developer in blocks 201 and 202. The assigning may be performed based on an expertise score for the first developer that was generated by expertise score vector module 501. Based on the first developer committing first code corresponding to the first work item in block 203, the first code may be reviewed and tested based on review and testing module 508. Problem records module 503 may receive a problem record corresponding to the first code in block 206, and expertise score vector module 501 may decrease the first developer's expertise score in block 207 based on the problem record. For example, a problem records metric in the first developer's expertise score may be decreased in block 207.

Embodiments of method 300 of FIG. 3 may be implemented in software component management system 500. For example, work item management module 505 may create the second work item in block 301 based on receiving of the problem record by problem records module 503, and assign the second work item to the second developer in block 302 based on an expertise score for the second developer that was generated by expertise score vector module 501. Based on the second developer committing second code corresponding to the second work item in block 303, the second code may be reviewed and tested based on review and testing module 508. Work item management module 505 may mark the second work item as resolved in block 304 based on the second code resolving the problem associated with the problem record. Expertise score vector module 501 may increase the first developer's expertise score in block 207 based on resolution of the problem in block 305. For example, a problem records metric in the second developer's expertise score may be increased in block 305.

Embodiments of method 400 of FIG. 4 may be implemented in software component management system 500. For example, work item management module 505 may identify, in block 401, a set of work items corresponding to a particular software component code base 510A that are marked as resolved. The work item management module 505 may also identify the developers that own the set of work items, and receive expertise scores for each of the identified developers from expertise score vector module 501 in block 402. The received expertise scores may be calculated based on metrics in the expertise score vectors that are related to the particular software component code based 510A. The work item management module 505 may also determine an average of the received expertise scores in block 403. The problem records module 503 may receive a new problem record in block 404, and the work item management module 505 may create a new work item based on the new problem record and assign the new work item to a developer having an expertise score that is greater than or equal to the determined average, based on an expertise score for the developer that is received from expertise score vector module 501.

It is to be understood that the block diagram of FIG. 5A is not intended to indicate that the system 500 is to include all of the components shown in FIG. 5A. Rather, the system 500 can include any appropriate fewer or additional components not illustrated in FIG. 5A (e.g., additional memory components, embedded controllers, functional blocks, connections between functional blocks, modules, inputs, outputs, etc.). Further, the embodiments described herein with respect to system 500 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Turning now to FIG. 5B, an expertise score vector module 501 is generally shown in accordance with one or more embodiments of the present invention. Expertise score vector module 501 of FIG. 5B corresponds to expertise score vector module 501 of FIG. 5A, and manages a plurality of expertise score vectors 502A-N. Expertise score vector module 501 includes an expertise score vector update module 520, which may update any field in an expertise score vector 502N based on data from problem records module 503, work item management module 505, code analysis module 507, and review and testing module 508 in software component management system 500.

Expertise score calculation module 521 may determine an expertise score for a developer based on the developer's expertise score vector 502N. An expertise score may be determined based on any appropriate subset of the fields in expertise score vector 502N, and the various fields in expertise score vector 502N may each be given any appropriate weight in calculating an expertise score. An expertise score may be calculated by expertise score calculation module 521 for a specific skill in some embodiments, such that only fields related to the specific skill are used to calculate the expertise score for the specific skill. In some embodiments, an expertise score that is calculated for a specific skill or software component may be used to assign work items to developers by work item management module 505 as described in method 200 of FIG. 2 and method 300 of FIG. 3. Developer classification module 522 may determine a classification for a developer based on an expertise score from expertise score calculation module 521. In some embodiments, the developer classification that is calculated by developer classification module 522 may be used to assign work items to developers as described in method 200 of FIG. 2, method 300 of FIG. 3, and method 400 of FIG. 4.

Expertise score vector 502N corresponds to a single developer in an organization. Expertise score vector 502N includes a developer and team identifier 530, which includes a unique identifier of the developer corresponding to expertise score vector 502N, and any teams that the developer is part of. A developer may be part of multiple teams in some embodiments. Expertise score vector 502N includes a plurality of data fields corresponding to the developer.

Expertise score vector 502N may include 521 respective component mastery metrics 531A-N for each software component that the developer has contributed work to. Component mastery metrics 531A-N may include an amount of time required by the developer to produce a unit of contribution to the associated software component. The unit of contribution may be measured in any appropriate manner (e.g. task completed, or lines of code). A number of errors or defects found in committed code by, for example, code analysis module 507 and/or review and testing module 508, that is related to a specific software component may also be tracked. For example, a number of defects detected in code per unit of contribution (e.g., lines of code or number of tasks) for a specific software component may be stored in component mastery metrics 531A-N. The component mastery metrics 531A-N may also include an amount of time spent on the software component, and a total number of contributions made to the software component. Developer classification module 522 may classify the developer with respect to a specific software component based on a set of component mastery metrics 531A, or an overall component mastery metric corresponding to the specific software component. Work items may be assigned to the developer based on the classifications determined by developer classification module 522, and also based on work queue points module 540.

Expertise score vector 502N may include a plurality of developer skill metrics 532A-N. Each individual set of developer skill metrics 532A-N may correspond to a specific skill (e.g., a programming language, a programming technique, such as recursion or multithreading, or a specific hardware element) possessed by the developer. Any appropriate metrics, including skill level and time spent on the skill, may be maintained in the developer skill metrics, such as developer skill metrics 532A, corresponding to a specific skill. Developer skill metrics 532A-N may be used in block 203 of method 200 of FIG. 2, and blocks 303 and 304 of method 300 of FIG. 3, to select developers to assign to a particular work item. The developer skill metrics 532A-N may include any appropriate metrics, including but not limited to a language set (e.g., Java, Python, C, etc.), coding techniques, and code patterns. Developer skill metrics 532A-N may track any appropriate particular techniques or technologies, including but not limited to recursion, loops, thread management, mutex locks, and interfacing with specific subcomponents. The developer skill metrics 532A-N may track a number of commits by the developer per skill to quantify an amount of experience the developer has regarding the skill. Errors in code committed that is related to the skill may also be tracked. A number of errors or defects found in committed code by, for example, code analysis module 507 and/or review and testing module 508, that are related to the skill may also be tracked. For example, a number of defects detected in code per unit of contribution (e.g., lines of code or number of tasks) for a specific skill may be stored in developer skill metrics 532A-N. A code contribution by the developer may be scanned by code analysis module 507 (using, for example, static code analysis and/or NLP) to identify what the code does and any techniques that are implemented in the code contribution, and the developer skill metrics 532A-N may be updated based on the scanning. Expertise score vector 502N may also include code quality metrics 533, problem records metrics 534, regression testing metrics 535, and code review change metrics 536. In some embodiments, problem records metrics 534 may be decreased based on a developer introducing a problem into a software component, as described with respect to block 207 of method 200 of FIG. 2. In some embodiments, problem records metrics 534 may be increased based on a developer resolving the problem in the software component, as described with respect to block 305 of method 300 of FIG. 3.

It is to be understood that the block diagram of FIG. 5B is not intended to indicate that the expertise score vector module 501 is to include all of the components shown in FIG. 5B. Rather, the expertise score vector module 501 can include any appropriate fewer or additional components not illustrated in FIG. 5B (e.g., additional memory components, embedded controllers, functional blocks, connections between functional blocks, modules, inputs, outputs, etc.). Further, the embodiments described herein with respect to expertise score vector module 501 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments. Further, expertise score vector 502N is shown for illustrative purposes only. Embodiments of an expertise score vector such as expertise score vector 502N may include any appropriate number and type of data fields in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processor, a problem record associated with a first work item of a software component, the first work item being associated with a first developer;
creating a second work item corresponding to the problem record;
assigning the second work item to a second developer;
determining that computer code from the second developer resolves the problem record; and
based on determining that the problem record is resolved, increasing an expertise score of the second developer.

2. The computer-implemented method of claim 1, comprising, based on receiving the problem record associated with the first work item, decreasing an expertise score of the first developer.

3. The computer-implemented method of claim 1, comprising:
determining a plurality of work items associated with resolved problem records for the software component, and determining a plurality of developers associated with the plurality of work items.

4. The computer-implemented method of claim 3, comprising:
for each of the plurality of developers, determining a respective expertise score; and
determining an average of the determined respective expertise scores.

5. The computer-implemented method of claim 4, comprising:
receiving a new problem record for the software component;
creating a third work item corresponding to the new problem record; and
assigning the third work item to a developer having an expertise score that is higher than the determined average.

6. The computer-implemented method of claim 4, wherein a respective expertise score for a developer is determined based on a subset of metrics that are related to the software component from an expertise score vector of the developer.

7. The computer-implemented method of claim 1, wherein creating the second work item comprises applying natural language processing to the problem record to extract keywords, and constructing the second work item based on the keywords.

8. A system comprising:
a memory having computer readable instructions; and
one or more processors for executing the computer readable instructions, the computer readable instructions controlling the one or more processors to perform operations comprising:
receiving a problem record associated with a first work item of a software component, the first work item being associated with a first developer;
creating a second work item corresponding to the problem record;
assigning the second work item to a second developer;
determining that computer code from the second developer resolves the problem record; and
based on determining that the problem record is resolved, increasing an expertise score of the second developer.

9. The system of claim 8, comprising, based on receiving the problem record associated with the first work item, decreasing an expertise score of the first developer.

10. The system of claim 8, comprising:
determining a plurality of work items associated with resolved problem records for the software component, and determining a plurality of developers associated with the plurality of work items.

11. The system of claim 10, comprising:
for each of the plurality of developers, determining a respective expertise score; and
determining an average of the determined respective expertise scores.

12. The system of claim 11, comprising:
receiving a new problem record for the software component;
creating a third work item corresponding to the new problem record; and
assigning the third work item to a developer having an expertise score that is higher than the determined average.

13. The system of claim 11, wherein a respective expertise score for a developer is determined based on a subset of metrics that are related to the software component from an expertise score vector of the developer.

14. The system of claim 8, wherein creating the second work item comprises applying natural language processing to the problem record to extract keywords, and constructing the second work item based on the keywords.

15. A computer program product comprising a computer readable storage medium having program instructions embodied therewith, the program instructions executable by a processor to cause the processor to perform operations comprising:
receiving a problem record associated with a first work item of a software component, the first work item being associated with a first developer;
creating a second work item corresponding to the problem record;
assigning the second work item to a second developer;
determining that computer code from the second developer resolves the problem record; and
based on determining that the problem record is resolved, increasing an expertise score of the second developer.

16. The computer program product of claim 15, comprising, based on receiving the problem record associated with the first work item, decreasing an expertise score of the first developer.

17. The computer program product of claim 15, comprising:
determining a plurality of work items associated with resolved problem records for the software component, and determining a plurality of developers associated with the plurality of work items.

18. The computer program product of claim 17, comprising:
for each of the plurality of developers, determining a respective expertise score; and
determining an average of the determined respective expertise scores.

19. The computer program product of claim 18, comprising:
receiving a new problem record for the software component;
creating a third work item corresponding to the new problem record; and
assigning the third work item to a developer having an expertise score that is higher than the determined average.

20. The computer program product of claim 18, wherein a respective expertise score for a developer is determined based on a subset of metrics that are related to the software component from an expertise score vector of the developer.
